(19) United States
(12) Patent Application Publication
(10) Pub. No.: US 2016/0349409 A1
(43) Pub. Date: Dec. 1, 2016

(54) PHOTOVOLTAIC SHADE IMPACT PREDICTION

(71) Applicant: DOW GLOBAL TECHNOLOGIES LLC, Midland, MI (US)

(72) Inventors: Stephen G. Pisklak, Hockessin, DE (US); James J. O'Brien, Midlnad, MI (US)

(21) Appl. No.: 15/104,404

(22) PCT Filed: Nov. 10, 2014
(86) PCT No.: PCT/US2014/064730

§ 371 Date: Jun. 14, 2016

Related U.S. Application Data
(60) Provisional application No. 61/904,606, filed on Nov. 15, 2013.

(51) Int. Cl. G01W 1/10; G01W 1/12

(52) U.S. Cl. CPC G01W 1/10; G01W 1/12

(57) ABSTRACT

Photovoltaic shade impact prediction processes include obtaining a three-dimensional model of a subject, associating an identifier of a camera image with a location of the camera disposed on the subject. The processes also include receiving an image of the sky captured by the camera, and the identifier, measuring pixel brightness of the image, estimating shade object perimeters in spherical coordinates based on the pixel brightness, and displaying a representation of the shade object perimeters in the model at the location of the camera based on the camera image identifier. The representation of the shade object perimeters is oriented based on a tilt angle and azimuth angle of the subject surface. The processes further include estimating a size and position of shade objects in real world three-dimensional space based on the spherical coordinates of the shade object perimeters, and creating an irradiance map for the subject surface.

### BACKGROUND

The present disclosure relates generally to solar surveys and, more particularly, to photovoltaic shade impact prediction.

Solar resource prediction field surveys are performed using tools which seek to provide an indication of “solar access,” which is a quantifiable measure of total irradiance available to a particular area. These tools, while useful, present some disadvantages in terms of measurement errors (e.g., point errors and interpolation errors) and processing burdens. In particular, the type of prediction tool used can render significant inaccuracies in estimating shade impact on a solar array. For example, it is possible to overestimate shade impact based on highly localized shade from trees and other nearby objects that are not accurately accounted for in the analyses, as well as diffuse light conditions that can reduce the impact of shade. These errors can be significant enough to render a potential home or building ineligible for state incentives or may greatly reduce the amount of incentives for which the owner may qualify.

Further, the overall process of some existing tools is manually intensive and requires a considerable amount of analysis after the survey is complete to determine solar access results. Finally, these tools are limited to homes and buildings that are already constructed.

It is desirable, therefore, to provide a tool that estimates total available irradiance with greater efficiency and accuracy and that can be performed for both pre-existing structures as well as for architectural designs or models of a structure.

### SUMMARY

In accordance with an embodiment, a method for implementing photovoltaic shade impact prediction is provided. The method includes obtaining, via a computer processing device, a three-dimensional model of a subject under survey, and associating an identifier of a camera image with a location of the camera disposed on the subject. The camera is positioned on a surface of the subject such that a lens of the camera is oriented to coincide with an orientation of the surface. The method also includes receiving an image of the sky captured by the camera. The image includes the identifier. The method further includes measuring pixel brightness of the image and factoring out pixels having a brightness value that exceeds a threshold, estimating shade object perimeters in spherical coordinates based on the pixel brightness, and displaying, on the computer processing device, a representation of the shade object perimeters in the three-dimensional model at the location of the camera based on the identifier of the camera image. The representation of the shade object perimeters is oriented based on a tilt angle and azimuth angle of the surface of the subject. The method also includes estimating a size and position of shade objects in real world three-dimensional space based on the spherical coordinates of the shade object perimeters, and creating an irradiance map for the surface based on shade object locations, orientation of the surface, and local typical weather data.

In accordance with a further embodiment, a system for implementing photovoltaic shade impact prediction is provided. The system includes a computer processing device and an application executable by the computer processor. The application is configured to obtain a three-dimensional model of a subject under survey, and associate an identifier of a camera image with a location of the camera disposed on the subject. The camera is positioned on a surface of the subject such that a lens of the camera is oriented to coincide with an orientation of the surface. The application is further configured to receive an image of the sky captured by the camera. The image includes the identifier. The application is also configured to measure pixel brightness of the image and factor out pixels having a brightness value that exceeds a threshold, estimate shade object perimeters in spherical coordinates based on the pixel brightness, and display a representation of the shade object perimeters in the three-dimensional model at the location of the camera based on the identifier of the camera image. The representation of the shade object perimeters is oriented based on a tilt angle and azimuth angle of the surface of the subject. The application is also configured to estimate a size and position of shade objects in real world three-dimensional space based on the spherical coordinates of the shade object perimeters, and create an irradiance map for the surface based on shade object locations, orientation of the surface, and local typical weather data.

In accordance with yet a further embodiment, a computer program product for implementing photovoltaic shade impact prediction is provided. The computer program product includes a computer storage medium having computer program instructions embodied thereon, which when executed by a computer processing device causes the computer processing device to implement a method. The method includes obtaining a three-dimensional model of a subject under survey, and associating an identifier of a camera image with a location of the camera disposed on the subject. The camera is positioned on a surface of the subject such that a lens of the camera is oriented to coincide with an orientation of the surface. The method also includes receiving an image of the sky captured by the camera. The image includes an identifier. The method further includes measuring pixel brightness of the image and factoring out pixels having a brightness value that exceeds a threshold, estimating shade object perimeters in spherical coordinates based on the pixel brightness, and displaying a representation of the shade object perimeters in the three-dimensional model at the location of the camera based on the identifier of the camera image. The representation of the shade object perimeters is oriented based on a tilt angle and azimuth angle of the surface of the subject. The method also includes estimating a size and position of shade objects in real world three-dimensional space based on the spherical coordinates of the shade object perimeters, and creating an irradiance map for the surface based on shade object locations, orientation of the surface, and local typical weather data.

### BRIEF DESCRIPTION OF THE DRAWINGS

FIG. 1 depicts a system upon which photovoltaic shade impact prediction processes may be implemented in accordance with an embodiment;

FIG. 2 depicts a flow diagram of a process for implementing photovoltaic shade impact prediction in accordance with an embodiment;

FIG. 3 depicts a data structure for use in implementing the photovoltaic shade impact prediction processes in accordance with an embodiment;

FIG. 4 depicts a diagram of a three-dimensional image of a survey subject and shade object perimeter estimates in spherical coordinates generated by the photovoltaic shade impact prediction processes in accordance with an embodiment;

FIG. 5 depicts a diagram of multiple shade object perimeter coordinate estimates of FIG. 4 and corresponding real-world shade object generated by the photovoltaic shade impact prediction processes in accordance with an embodiment; and

FIG. 6 depicts a diagram of an irradiance map generated via the photovoltaic shade impact prediction in accordance with an embodiment.

### DETAILED DESCRIPTION OF THE INVENTION

Exemplary embodiments provide a tool for implementing photovoltaic shade impact prediction that efficiently and accurately estimates total available irradiance for a subject under survey, which subject can be either a pre-existing structure or an architectural design or model of the structure. A surveyor can process data from the tool on-site and in a single visit to the site.

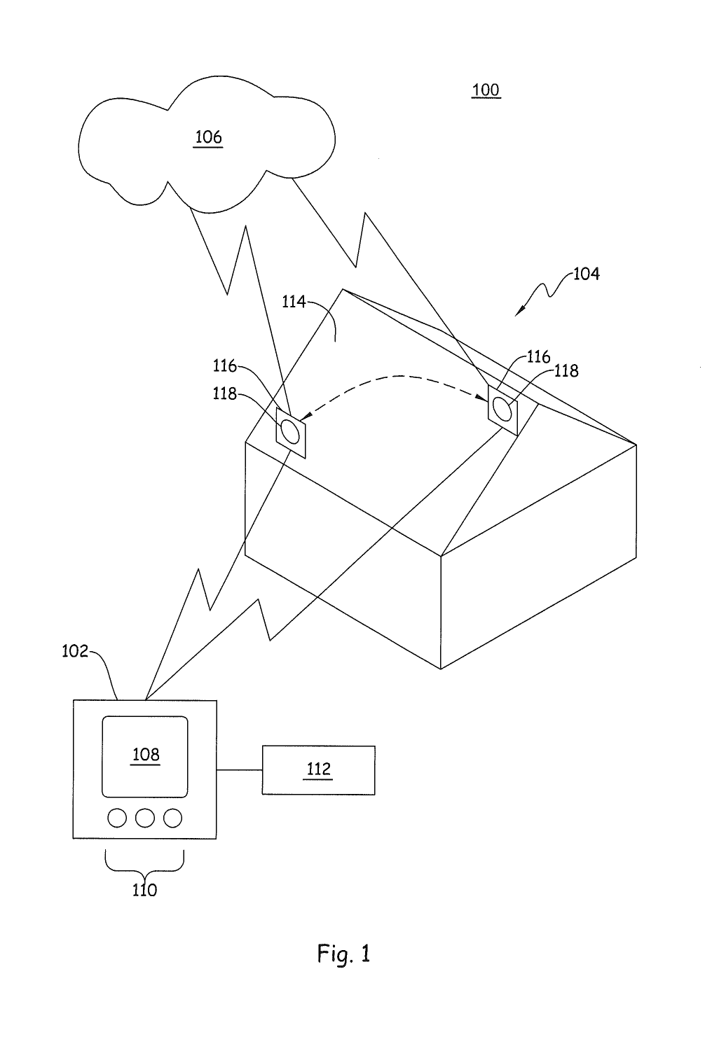

Turning now to FIG. 1, a system 100 for implementing photovoltaic shade impact prediction processes will now be described in an embodiment. The system 100 includes a computer processing device 102, a survey subject 104, a camera 116, and one or more networks 106.

In an exemplary embodiment, the computer processing device 102 is a mobile computer, e.g., a tablet PC, laptop, smartphone, etc. that has wireless communication capabilities. The computer processing device 102 includes a display screen 108, input controls 110, a processor and internal memory (not shown). The computer processing device 102 executes an application 112 for implementing the exemplary photovoltaic shade impact prediction processes described herein.

The display screen 108 displays three-dimensional models of survey subjects, as well as interposed or superimposed processed image information at corresponding locations in the models. The display screen 108 also displays user-selected and specified array areas that can be defined through an interface of the application 112, e.g., via the input controls 110, which may be physical buttons or knobs on the computer processing device 102, and/or may be implemented directly via the display screen 108 using touchscreen technology. The display screen 108 further displays useful information, such as irradiance maps, solar array layouts, and bills of material for solar array projects.

The memory stores data relating to the business operations of the surveyor and may be implemented using a variety of devices for storing electronic information. It is understood that the memory may be implemented internal to the computer processing device 102 or it may be a separate physical device that implemented as one or more storage devices dispersed across the networks(s) 106 and each of the storage devices may be logically addressable as a consolidated data source across a distributed environment that includes network(s) 106. Information stored in the storage devices may be retrieved and manipulated via the computer processing device 102.

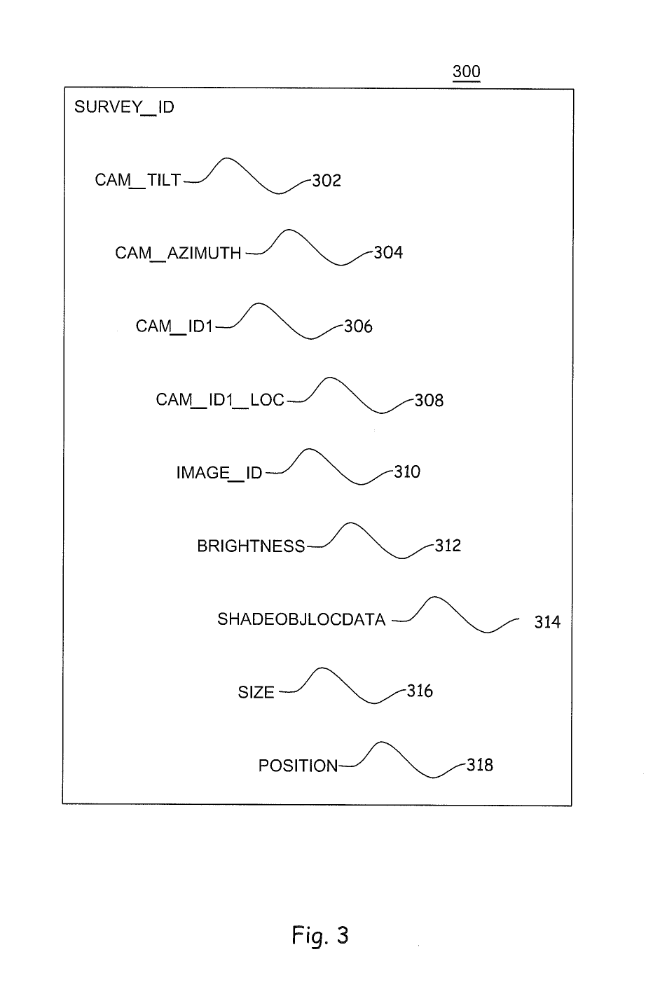

In an embodiment, the memory stores three-dimensional models of survey subjects, images and image information associated with surveys, irradiance maps, solar array layouts generated from the surveys, solar array parts catalogs, and bills of material generated for solar array projects. A sample data structure for storing the image and image-related information for processing by the application 112 is shown and described in FIG. 3.

The application 112 may include various components that facilitate the implementation of the photovoltaic shade impact prediction. For example, the components may include a three-dimensional modeling component, an edge detection component, an irradiance mapping component, and a bill of materials and catalog processing component. Alternatively, the computer processing device 102 may access and execute (e.g., either from the memory of the computer processing device 102 or by remote access over one or more network(s) 106) additional applications that perform the functionality of the components listed above. In a further embodiment, one or more of the above components may be accessed, e.g., in conjunction with an application programming interface with the application 112.

The survey subject 104 represents the subject of the solar impact survey. The survey subject may be a physical real world structure such as a home or business. In another embodiment, the survey subject 104 may be a virtual representation (e.g., a three-dimensional model) of a structure that is yet to be built.

The network(s) 106 may include any types of known networks including, but not limited to, a wide area network (WAN), a local area network (LAN), a global network (e.g., Internet), a virtual private network (VPN), and an intranet. The network(s) 106 may be implemented using a wireless networks or any kind of physical network implementation known in the art. Wireless networks may include satellite, cellular, and/or terrestrial technologies. In an exemplary embodiment, the computer processing device 102 may be coupled to the cameras 116A and 116B via a short-range wireless network, such as WiFi network or a BlueTooth™-enabled network.

The camera 116 may be an image capturing device that is configured to capture images from multiple locations. The camera 116 may be a single, stand-alone device or may be integrated into the computer processing device 102. The camera 116 may be any suitable image capturing device that includes wireless communication capabilities (e.g., short-range wireless capabilities using WiFi and/or BlueTooth, and/or long-range capabilities using cellular, satellite, or terrestrial technologies). The camera 116 utilizes a lens 118, e.g., a fisheye lens or a wide-angle lens suitable for capturing a greater area of the sky.

In an embodiment, the camera 116 captures images of the sky from defined locations at the survey subject 104 and communicates these images in real time to the computer processing device 102 via, e.g., a short-range wireless communication technology such as WiFi or Bluetooth, or wired directly to the computer processing device 102. In an alternative embodiment, the camera 116 may be integrated with the computer processing device 102, e.g., as a single device.

In an embodiment, the camera images are identifiable by the computer processing device 102 (i.e., distinguishable from each other) by a unique identifier that may be transmitted to the computer processing device 102 with the images. In turn, the images from each camera location may be uniquely identified by the computer processing device 102, e.g., via a timestamp attributed to the images that identifies the date and time the image was captured. The camera 116 may be programmable for directing the camera to provide this identification information with corresponding images. It will be understood that other identification methods may be employed in order to realize the advantages of the embodiments described herein. A record of these images, as well as other survey information is saved by the computer processing device 102, e.g., in its internal memory or in a remote storage device over network(s) 106.

In an embodiment, the camera 116 is disposed on a surface 114 of the survey subject 104 and its lens 118 is oriented to coincide with the orientation of the surface 114. For example, if the surface is oriented to face South at a tilt angle of 145 degrees, the camera and lens will be oriented to face South at the same tilt angle. This orientation information is provided to the computer processing device 102 for use by the application 112 in performing the photovoltaic shade impact prediction processes.

While only a single camera 116 is shown in FIG. 1, it will be understood that multiple cameras may be employed to implement the photovoltaic shade impact prediction processes. The number and physical placement of the cameras may be determined based on the size of the survey subject and other desired criteria. The single camera shown in FIG. 1 is provided for ease of illustration and is not to be construed as limiting in scope.

As indicated above, the survey subject 104 may be a physical structure or may be a virtual representation of a structure. If the subject 104 is a physical structure, the camera 116 is disposed on the surface 114 at a desired location. If the subject 104 is a three-dimensional model of a structure, the camera 116 can be disposed on any reference surface that is easily replicated virtually within the model. For example, the camera 116 may be placed directly on the ground, as long as its location is noted. Alternatively, the camera 116 may be mounted on a pole at a desired height.

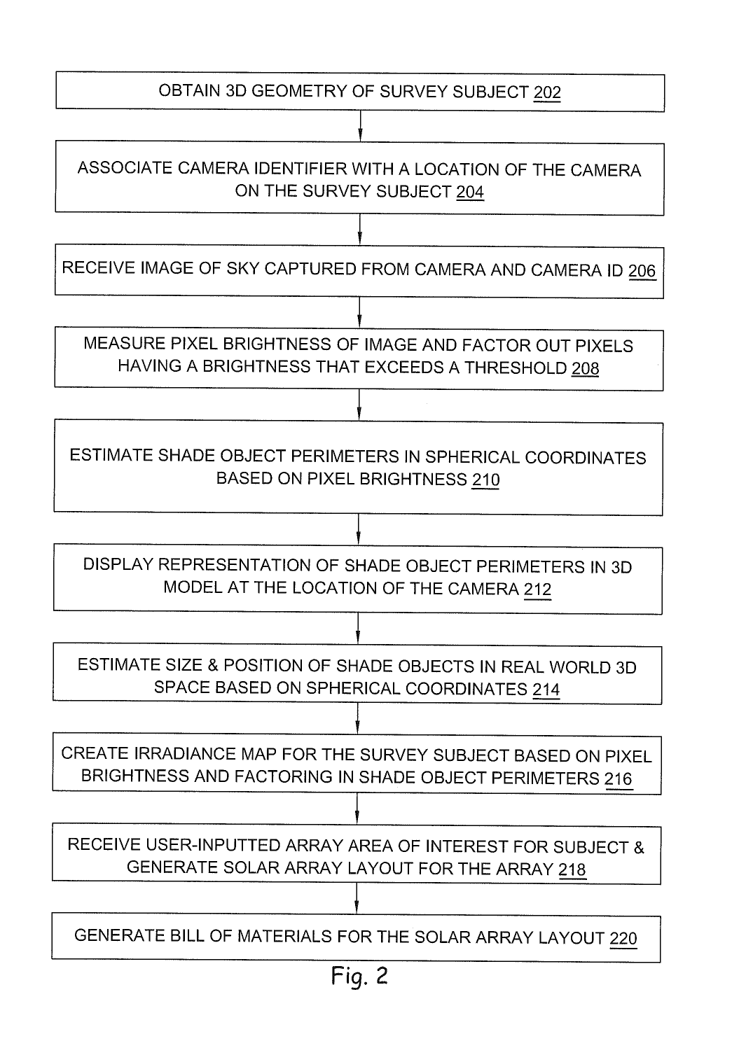

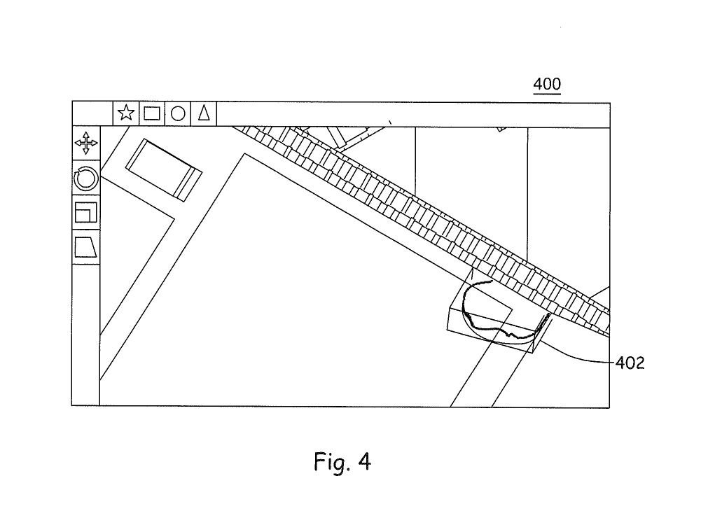

Turning now to FIGS. 2-6, a flow diagram of a process for implementing the photovoltaic shade impact prediction for a survey subject, in conjunction with a data structure for use in storing image data, as well as a sequence of diagrams that depict the visual outputs of the photovoltaic shade impact prediction processes, will now be described in an embodiment. The diagrams depicted in FIGS. 4-6 may be visually represented on the display screen 108 of the computer processing device 102 and may be manipulated (as described herein) by a user of the computer processing device 102.

At block 202, the computer processing device 102 obtains three-dimensional model of the subject 104 under survey. This information may be created from information input by the surveyor (e.g., a three-dimensional modeling component of the application 112) or may be imported from a remote storage location. Diagrams 400, 500, and 600 of sample three-dimensional models of the survey subject 104 are shown in FIGS. 4-6.

The surveyor places one or more cameras (e.g., camera 116) on a surface (e.g., surface 114) of the subject (e.g., subject 104). The lens of the camera 116 is oriented to coincide with the orientation of the surface 114. At block 204, the application 112 associates an identifier of the camera 116 (e.g., if multiple cameras are used) with its location on the survey subject. For example, using the three-dimensional modeling features of the modeling component, three-dimensional coordinates of the camera location can be associated with the corresponding camera 116.

At block 206, the computer processing device 102 receives images of the sky captured by the camera 116, along with image identifiers. As shown in FIG. 3, the data structure 300 is configured to store information. For example, images are stored as CAM_ID1_LOC 308 and IMAGE_ID 310 for a particular camera (CAM_ID1 306), tilt angle information is stored as CAM_TILT 302, and azimuth is stored as CAM AZIMUTH 304.

At block 208, the application 112 measures the pixel brightness of the image and factors out those pixels having a brightness value that exceeds a threshold level. As shown in FIG. 3, the image is stored as IMAGE_ID 310, and the brightness threshold value is stored as BRIGHTNESS 312 for that image.

At block 210, the application 112 estimates shade object perimeters in spherical coordinates based on the pixel brightness. This may be implemented, e.g., using an edge detection component of application 112. In FIG. 3, the shade object perimeter information is stored as SHADEOBJLOCDATA 314.

At block 212, a representation of the shade object perimeters in the three-dimensional model is displayed at the location of the camera based on the identifier of the camera image. The representation of the shade object perimeters is oriented based on the tilt angle and azimuth angle of the surface. FIG. 4 is a diagram 400 illustrating a portion of the survey subject 104 and one shade object perimeter 402 in spherical coordinates that is in correspondence with the camera 116 location of FIG. 1. The diagram 400 may be displayed on the computer processing device 102.

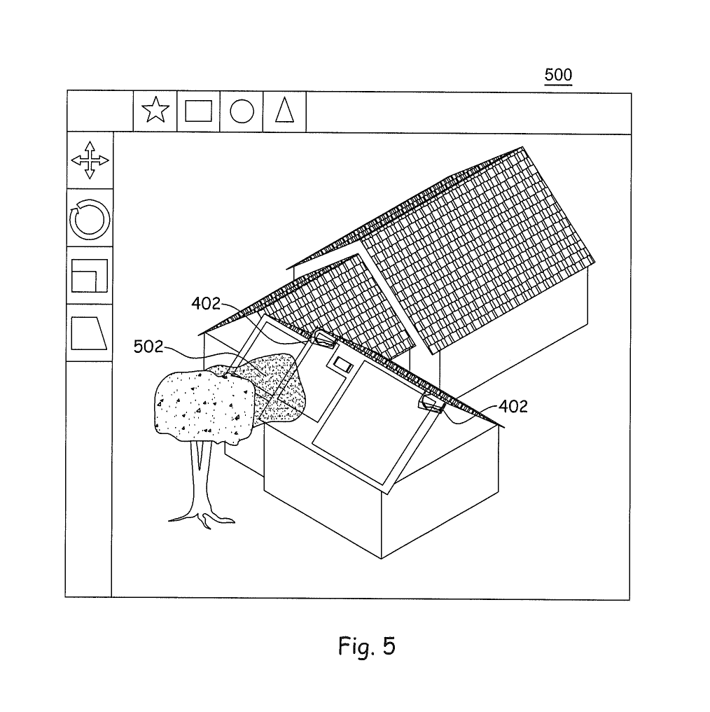

At block 214, the application 112 estimates a size and position of the shade objects in real world three-dimensional space based on the spherical coordinates of the shade object perimeters. In FIG. 3, the size and position data is stored as SIZE 316 and POSITION 318, respectively, for the particular image location. As shown in FIG. 5, a diagram 500 illustrates the shade object 502 superimposed in real world space corresponding to the location or proposed location of the subject 104. For example, the shade object 502 may be a grouping of one or more trees that are estimated in three-dimensional space using the perimeters 402 projected from the surface locations via the identifier. Shadow perimeter locations 402 are shown in corresponding locations of the subject.

In an embodiment, the size and position of the shade objects are estimated in real world three-dimensional space using the following process: 1) horizontal boundaries of the shade objects in the real world three-dimensional space are identified; 2) horizontal projections of perimeter vectors that intersect within the shade object horizontal boundaries are determined; 3) points within the horizontal boundaries where perimeter vector horizontal projections intersect are identified; 4) another set of intersection points are identified between the vertical projections of the horizontal intersection points and the perimeter vectors; 5) multiple intersection points along a single vertical projection are resolved by weighting points in relation to their distance from their respective perimeter image locations, then creating a single point that best represents the weighting; 6) creating a representation of a surface based on the resolved points; and 7) applying the representation of the surface to a process that creates an irradiance map.

In an embodiment, the horizontal boundaries of the shade objects in the real world three-dimensional space are identified by tracing objects obtained through aerial imagery. In another embodiment, the horizontal boundaries of the shade objects in the real world three-dimensional space are identified by defining a shade impact zone; one such example would be bound by the horizontal front edge of the subject surface, a parallel line 100 feet horizontally from the front edge, and azimuth angles between 80 degrees and 280 degrees from the front edge endpoints of the subject surface.

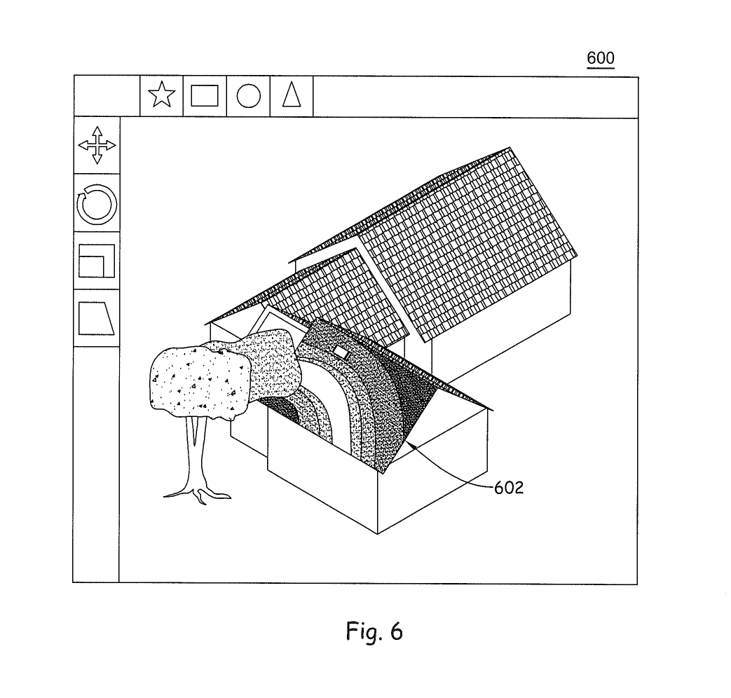

At block 216, an irradiance mapping component of the application 112 creates an irradiance map for the subject based on the shade object locations, subject surface orientation, and local typical weather. For example, by way of non-limiting example, if a geographic region is determined to have a high number or percentage of overcast days or a high amount of rainfall, this information can be factored into the process that creates the irradiance map. This information may be stored using the data structure (not shown). As illustrated in FIG. 6, an irradiance map 600 of the subject (e.g., roof 602) illustrates solar access according to varying colors (and may be represented using hatch markings).

At block 218, the application 112 provides an option to specify an array area of interest (e.g., via the interface and input controls 110 or through touchscreen technology in which the surveyor touches the model at the array area of interest). Once specified, the application 112 may automatically generate a bill of materials for the array area of interest based on pre-defined constraints. This may be implemented by mapping solar array inputs to part numbers and a corresponding parts catalog database. A bill of materials and catalog processing component of the application 112 may be accessed for facilitating this feature.

At block 220, the application 112 may automatically generate a bill of materials for the solar array layout.

Technical effects of the invention provide photovoltaic shade impact predictions that efficiently and accurately estimate total available irradiance for a subject under survey, which subject can be either a pre-existing structure or an architectural design or model of the structure. Using a mobile device, a surveyor can process data from the tool on-site and in a single visit to the site

It will be appreciated that aspects of the present invention may be embodied as a system, method or computer program product and may be implemented in hardware, software, or a combination thereof. Additionally, aspects of the present invention may be implemented as a computer program product embodied in computer readable media and embodied with computer readable program code.

It will be appreciated that aspects of the present invention are described herein with reference to flowchart illustrations and/or block diagrams of methods, apparatus (systems) and computer program products according to embodiments of the invention. It will be understood that each block or step of the flowchart illustrations and/or block diagrams, and combinations of blocks or steps in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

1. A method for implementing photovoltaic shade impact prediction, the method comprising:
obtaining, via a computer processing device, a three-dimensional model of a subject under survey;
associating an identifier of a camera image with a location of a camera disposed on the subject, the camera positioned on a surface of the subject such that a lens of the camera is oriented to coincide with an orientation of the surface;
receiving an image of the sky captured by the camera, the image including the identifier;
measuring pixel brightness of the image and factoring out pixels having a brightness value that exceeds a threshold;
estimating shade object perimeters in spherical coordinates based on the pixel brightness;
displaying, on the computer processing device, a representation of the shade object perimeters in the three-dimensional model at the location of the camera based on the identifier of the camera image, the representation of the shade object perimeters is oriented based on a tilt angle and azimuth angle of the surface of the subject;
estimating a size and position of shade objects in real world three-dimensional space based on the spherical coordinates of the shade object perimeters; and
creating an irradiance map for the subject based on the shade object locations, orientation of the surface, and typical local weather data.

2. The method of claim 1, wherein the estimating the shade object perimeters in spherical coordinates based on the pixel brightness is implemented using an edge detection technique.

3. The method of claim 1, wherein the estimating the size and position of the shade objects in real world three-dimensional space based on the spherical coordinates of the shade object perimeters includes:
identifying horizontal boundaries of the shade objects in the real world three-dimensional space;
determining horizontal projections of perimeter vectors that intersect within the horizontal boundaries of the shade objects;
identifying points within the horizontal boundaries where perimeter vector horizontal projections intersect; and
identifying another set of intersection points between vertical projections of horizontal intersection points and the perimeter vectors.

4. The method of claim 3, further comprising resolving the points, comprising:
weighting the points in relation to a distance between the points and respective perimeter image locations;
creating a single point that most closely approximates the weighting;
creating a representation of a surface based on the resolved points; and
applying the representation of the surface to a process that creates the irradiance map.

5. The method of claim 1, wherein the estimating the size and position of the shade objects in real world three-dimensional space is implemented by tracing objects obtained through aerial imagery.

6. The method of claim 1, wherein the estimating the size and position of the shade objects in real world three-dimensional space is implemented by defining a shade impact zone.

7. The method of claim 1, further comprising:
providing, via the computer processing device, an option to specify an array area of interest; and
generating a solar array layout for the array area of interest, the solar array layout generated as a function of pre-defined constraints.

8. The method of claim 7, further comprising:
automatically generating, via the computer processing device, a bill of materials for the solar array layout.

9. A system for implementing photovoltaic shade impact prediction, comprising:
a computer processing device; and
an application executable by the computer processing device, the application configured to implement:
obtaining a three-dimensional model of a subject under survey;
associating an identifier of a camera image with a location of a camera disposed on the subject, the camera positioned on a surface of the subject such that a lens of the camera is oriented to coincide with an orientation of the surface;
receiving an image of the sky captured by the camera, the image including the identifier;
measuring pixel brightness of the image and factoring out pixels having a brightness value that exceeds a threshold;
estimating shade object perimeters in spherical coordinates based on the pixel brightness;
displaying a representation of the shade object perimeters in the three-dimensional model at the location of the camera based on the identifier of the camera image, the representation of the shade object perimeters is oriented based on a tilt angle and azimuth angle of the surface of the subject;
estimating a size and position of shade objects in real world three-dimensional space based on the spherical coordinates of the shade object perimeters; and
creating an irradiance map for the subject based on the shade object locations, orientation of the surface, and typical local weather data.

10. The system of claim 9, wherein the estimating the size and position of the shade objects in real world three-dimensional space based on the spherical coordinates of the shade object locations includes:
identifying horizontal boundaries of the shade objects in the real world three-dimensional space;
determining horizontal projections of perimeter vectors that intersect within the horizontal boundaries of the shade objects;
identifying points within the horizontal boundaries where perimeter vector horizontal projections intersect; and
identifying another set of intersection points between vertical projections of horizontal intersection points and the perimeter vectors;
wherein the application is further configured to resolve the points, comprising:
weighting the points in relation to a distance between the points and respective perimeter image locations;
creating a single point that most closely approximates the weighting;
creating a representation of a surface based on the resolved points; and
applying the representation of the surface to a process that creates the irradiance map.

11. The system of claim 9, wherein the estimating the size and position of the shade objects in real world three-dimensional space is implemented by tracing objects obtained through aerial imagery.

12. The system of claim 9, wherein the estimating the size and position of the shade objects in real world three-dimensional space is implemented by defining a shade impact zone.

13. The system of claim 9, wherein the subject is one of a:
physical structure; and
a computer-simulated structure.

14. The system of claim 9, wherein the computer processing device is integrated with the camera as a single device.

15. A computer program product for implementing photovoltaic shade impact prediction, the computer program product comprising a computer storage medium having computer program instructions embodied thereon, which when executed by a computer processing device, causes the computer processing device to implement:
obtaining a three-dimensional model of a subject under survey;
associating an identifier of a camera image with a location of a camera disposed on the subject, the camera positioned on a surface of the subject such that a lens of the camera is oriented to coincide with an orientation of the surface;
receiving an image of the sky captured by the camera, the image including the identifier;
measuring pixel brightness of the image and factoring out pixels having a brightness value that exceeds a threshold;
estimating shade object perimeters in spherical coordinates based on the pixel brightness;
displaying a representation of the shade object perimeters in the three-dimensional model at the location of the camera based on the identifier of the camera image, the representation of the shade object perimeters is oriented based on a tilt angle and azimuth angle of the surface of the subject;
estimating a size and position of shade objects in real world three-dimensional space based on the spherical coordinates of the shade object perimeters; and
creating an irradiance map for the subject based on the shade object locations, orientation of the surface, and typical local weather data.
